(19) United States
(12) Patent Application Publication
(10) Pub. No.: US 2026/0367383 A1
(43) Pub. Date: Nov. 19, 2026

(54) Night vision binoculars

(71) Applicant: THALES, Meudon (FR)

(72) Inventor: Gabriel NARCY, SAINT HEAND (FR)

(21) Appl. No.: 19/136,879

(22) PCT Filed: Dec. 12, 2023
(86) PCT No.: PCT/EP2023/085391

§ 371 Date: Jun. 8, 2025

(30) Foreign Application Priority Data
Dec. 13, 2022 (FR) FR2213235

(51) Int. Cl. G02B 23/12; G02B 26/08

(52) U.S. Cl. CPC G02B 23/125; G02B 26/0891

(57) ABSTRACT

Night vision binoculars including an objective assembly having an optical axis, and an adjustment device for focusing the objective assembly, the adjustment device presenting an adjustment mode, designated the progressive mode, wherein the focus is achieved on the object planes not perpendicular to the optical axis of the objective assembly so as to allow for near-field focusing on a part of the field of view and far-field focusing on another part of the field of view.

### CROSS-REFERENCE TO RELATED APPLICATIONS

This application claims benefit under 35 USC § 371 of PCT Application No. PCT/EP2023/085391 entitled NIGHT VISION BINOCULARS, filed on Dec. 12, 2023 by inventor Gabriel Narcy, PCT Application No. PCT/EP2023/085391 claims priority of French Patent Application No. 22 13235, filed on Dec. 13, 2022.

### FIELD OF THE INVENTION

The present invention relates to night vision binoculars.

It more particularly relates to the focusing devices of the objective optical path of night vision binoculars.

### BACKGROUND OF THE INVENTION

The ergonomics of using night vision binoculars directly contribute to user viewing comfort and allows to ensure that the binoculars improve the night mobility of the infantryman as much as possible while generating least possible fatigue over time.

According to user typologies, the use of control rings is more, or less frequent (for example: switching from a focus of more than 10 meters for observing the general direction of displacement, to a focus of 1.5 m to 2 m for observing obstacles or other elements of attention near the feet).

Traditional available binoculars on the market have objectives presenting a standard field of 40° for a numerical aperture of F/1.2. The focusing of the objectives is done manually and according to focus planes perpendicular to the optical axis. The depth of field of these objectives allows to obtain a sharp image from 15 m to infinity when the focus is set at 30 m. Thus, for a focus set at 30 m, the image of an object observed at 2 m is blurred.

In particular, in the case of monocular binoculars, the user looks with one eye (called the intensified eye) through an optical system. Observation with this eye requires manipulating a control ring in order to adjust the focus on variable focus fields. The non-intensified eye retains its ability to accommodate the near or far field. In the case of bi-ocular devices, the user looks with both eyes at an intensified image captured by a single objective. Observation requires manipulating a control ring to adjust the focus on variable focus fields. In the case of binocular devices, the user looks through two independent optical paths, each comprising an intensifier tube. In this case, the user has a stereoscopic view of the observed scene. Observation requires manipulating two control rings to adjust the focus of each optical path on variable focus fields.

Thus, during user displacement, such objectives require manipulating a focus control ring of the objective in order to render a clear image of an object or a scene plane to be observed.

The night vision binoculars market is evolving and tends towards increasing fields, numerical aperture without loss of resolution while reducing equipment mass and increasing usability ergonomics. This evolution leads to proposing new, more complex optical architectures that can integrate new functionalities.

Nevertheless, the solutions identified in the state of the art proposing autofocus devices or increased depth of field present limitations when implemented in a hands-free night vision system (real-time imaging).

In particular, solutions consisting of increasing the depth of field are based on using a variable aperture diaphragm. The smaller the aperture, the greater the depth of field. The downside is a significant loss of light flux, making the system unusable at deep night levels (night illumination level 4 to 5<1 mlux on low albedo scenes).

Solutions integrating autofocus require a numerical analysis of the image associated with motorizing the objective focus. However, numerical analysis requires extracting flux from the useful incident flux on the tube, thus reducing usability capabilities at deep night levels. The sensor allowing the acquisition of the digital image must itself be a low-light sensor sufficiently resolved and sensitive (night 4 to 5), which is not achieved by the state of the art. Furthermore, the consumption associated with numerical analysis and focus motorization is such as to considerably reduce the autonomy of night vision binoculars.

Solutions integrating telemetry to determine the distance of the object to be observed are emissive and therefore likely to reduce discretion when using the equipment.

Finally, solutions based on using coupled phase filters and a deconvolution algorithm are only relevant in the case of digital image capture, and not in other cases.

There is therefore a need for night vision binoculars allowing to facilitate displacement of a user evolving in an environment where observed objects are both distant and close to the binoculars objective.

### SUMMARY OF THE DESCRIPTION

To this end, the present description has as its object the night vision binoculars comprising:
a. an objective assembly having an optical axis, and
b. a focus adjustment device of the objective, the adjustment device presenting an adjustment mode, called progressive mode, in which the focus is realized on object planes not perpendicular to the optical axis of the objective so as to allow near-field focusing on a part of the field of view and far-field focusing on another part of the field of view.

According to particular embodiments, the binoculars comprise one or more of the following features, taken alone or in any technically possible combinations:
the adjustment device comprises a first unit for adjusting the focus distance and a second unit for adjusting the angle between the optical axis and the normal to the object plane;
the adjustment device also presents an adjustment mode, called traditional mode, in which the focus is performed on object planes perpendicular to the optical axis;
the second adjustment unit comprises two complementary-shaped optical components joined together, at least one optical component, called the first component, being movable in rotation relative to the other optical component, called the second component, so as to modify the angle between the normal to the object plane and the optical axis, allowing to modify the focus difference between the top of the field of view and the bottom of the field of view vertically, called progressive effect;
the second adjustment unit presents at least:
   a. a. a configuration, called traditional, corresponding to the traditional mode of the adjustment device, the traditional configuration corresponding to a positioning of the first component relative to the second component such that the angle between the optical axis and the normal to the object plane is zero, thus allowing to achieve focusing on a plane perpendicular to the object plane,
   b. b. a configuration, called maximum progressive, corresponding to the progressive mode of the adjustment device, the maximum progressive configuration being a 180-degree rotation of the first component relative to the traditional configuration so that the progressive effect is maximum;
the second adjustment unit presents at least one configuration, called intermediate progressive, corresponding to:
   a. a. a first rotation of the first component by an angle strictly between 0° and 180° relative to the traditional configuration so as to obtain an intermediate progressive effect relative to the traditional configuration and the maximum progressive configuration, and
   b. b. a second rotation allowing to jointly drive in rotation the first component and the second component, until the far-field focus is on the top of the field of view and the near-field focus is on the bottom of the field of view;
the two optical components are chosen such that the progressive effect, induced by the rotation of at least one of the optical components, is linear over the vertical field extent;
the two optical components are two prismatic plates;
the two optical components are chosen such that the progressive effect, induced by the rotation of at least one of the optical components, is non-linear over the vertical field extent;
the two optical components are two lenses, for example, spherical, aspherical, or Freeform.

### BRIEF DESCRIPTION OF THE DRAWINGS

Other features and advantages of the invention will appear upon reading the following description of embodiments of the invention, given solely as an example and with reference to the drawings which are:

FIG. 1, a schematic representation of an example of night vision binoculars comprising an objective and a focus adjustment device of the objective,

FIG. 2, a schematic representation of focus distances for different zones of the field of view,

FIG. 3, a schematic representation of an example of an angle adjustment unit between the optical axis and the normal to the object plane, the adjustment unit being represented in three distinct configurations,

FIG. 4, a schematic representation of another example of an angle adjustment unit between the optical axis and the normal to the object plane, the adjustment unit being represented in three distinct configurations,

FIG. 5, a schematic representation of a mechanism able to pivot one of the optical components of the adjustment unit, allowing the angle between the optical axis and the normal to the object plane to be modified, and

FIG. 6, a schematic representation of a mechanism able to pivot, on the one hand, one of the optical components of the adjustment unit relative to the other optical component, and, on the other hand, both optical components together, so as to modify the angle between the optical axis and the normal to the object plane.

### DETAILED DESCRIPTION OF EMBODIMENTS

In the following description and drawings, the distances noted “d” and “D” are expressed in diopters, and the distances “1/d” and “1/D” are the corresponding distances in meters.

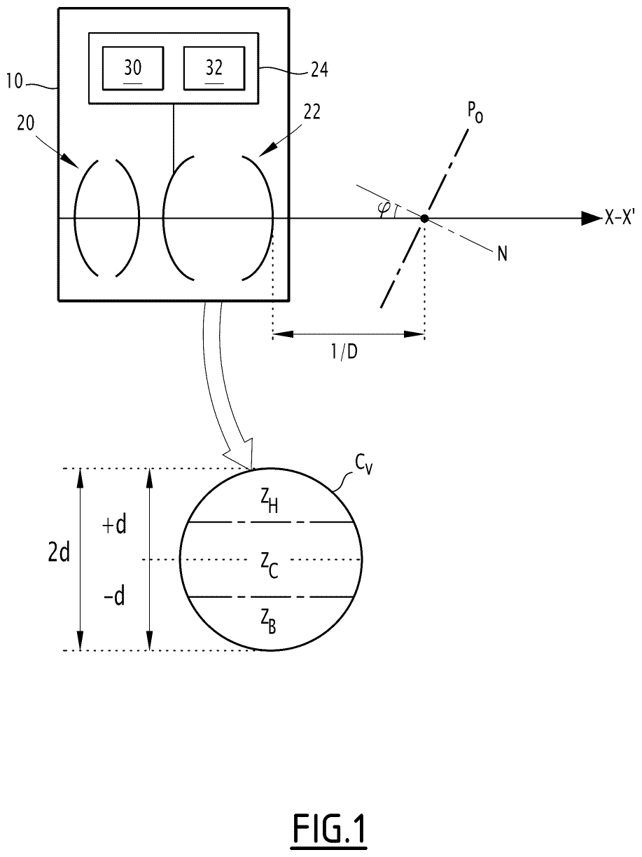

Night vision binoculars 10 are schematically illustrated in FIG. 1.

The binoculars 10 are, for example, intended to be mounted on a helmet or a head harness. Alternatively, the binoculars 10 are handheld by the user.

The night vision binoculars 10 are any type of night vision binoculars, notably monocular binoculars, binocular binoculars, binocular binoculars, or even panoramic binoculars (4 intensified paths). The binoculars 10 can also be connected binoculars and include data visualization elements.

As illustrated by FIG. 1, the binoculars 10 comprise an eyepiece 20, an objective assembly 22, and a focus adjustment device 24 of the objective 22.

The objective assembly 22 is an optical system typically including one or more optical elements (lenses, mirrors . . . ), as well as a light intensification device (tube). The objective assembly 22 presents an optical axis X-X′ represented in FIG. 1.

The adjustment device 24 is able to be manipulated by the user to adjust the focus of the objective assembly 22 on an object plane P_{O} of the scene. In particular, the adjustment device 24 is configurable by the user to adjust the focus distance 1/D. The focus distance 1/D is the distance between the objective assembly 22 and the intersection of the object plane P_{O} with the optical axis X-X′. The focus distance is typically adjusted for the center of the field of view (the center of the field of view must be sharp at the focus distance 1/D). Thus, for a focus on an object plane perpendicular to the optical axis, the entire field of view is sharp at the distance 1/D. This is not the case when the focus is made on an object plane not perpendicular to the optical axis: the top of the field will typically be sharp at a greater distance than the distance 1/D, and the bottom of the field will be sharp at a smaller distance than the distance 1/D. In this case, only the central zone of the field of view will be sharp at the distance 1/D.

The adjustment device 24 presents an adjustment mode, called progressive mode, in which the focus is achieved on the object planes P_{O} not perpendicular to the optical axis X-X′ of the objective assembly 22 (see FIG. 1) so as to allow near-field focusing on a part of the field of view C_{V} and far-field focusing on another part of the field of view C_{V}. By far-field focusing, it is meant that the focus is made on an object distant from the user, typically more than 10 meters, or less than 0.1 diopter. By near-field focusing, it is meant that the focus is achieved on an object close to the user, typically between 1 m and 3 m, or between 0.33 and 1 diopter.

Thus, in the progressive mode, the focus difference between the top of the field of view C_{V} (upper part at the edge of the field of view) and the bottom of the field of view C_{V} (lower part at the edge of the field of view) vertically, called progressive effect, is not zero. It depends on the angle φ between the optical axis X-X′ and the normal N to the object plane P_{O}.

More precisely, considering the field of view C_{V} according to the vertical, the far-field focus is made on the high zone Z_{H} of the field of view C_{V}, and the near-field focus is made on the low zone Z_{B} of the field of view C_{V}. FIG. 1 schematically illustrates different zones of the field of view C_{V}, namely the high zone Z_{H}, the center zone Z_{C}, and the low zone Z_{B}, as well as the progressive effect ±d vertically (in diopters).

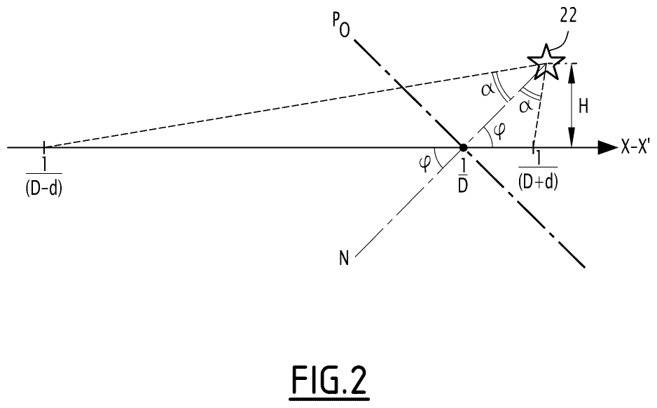

In particular, as illustrated by FIG. 2, for an objective assembly 22 located at a height H from the ground, and a linear variation of the progressive effect of ±d (diopters) vertically, relative to the center of the field of view C_{V}, the focus is sharp:
at the center of the field of view at a distance 1/D, or D in diopters,
sharp at the lower edge of the field of view C_{V} (lower part) at a distance expressed in diopters of (D+d), and
sharp at the upper edge of the field of view C_{V} (upper part) at a distance expressed in diopters of (D−d).

Preferably, the adjustment device 24 also presents an adjustment mode, called traditional mode, in which the focus is achieved on the object planes P_{O} perpendicular to the optical axis X-X′. In the traditional mode, the vertical focus is uniform over the field of view C_{V} (zero progressive effect).

As illustrated by the example of FIG. 1, the adjustment device 24 comprises a first unit 30 for adjusting the focus distance 1/D (D in diopters) and a second unit 32 for adjusting the angle φ between the optical axis X-X′ and the normal N to the object plane P_{O}.

The first adjustment unit 30 is able to be controlled by the user. The first adjustment unit 30 is typically a manual adjustment mechanism for the focus distance 1/D (distance between the objective assembly 22 and the intersection of the object plane P_{O} with the optical axis X-X′) depending on the targeted object. The objective assembly 22 is typically mounted in a barrel, and the first adjustment unit 30 allows to displace in translation the barrel of the objective assembly 22 to achieve the focus on a targeted object.

The second adjustment unit 32 is an additional unit relative to traditional night vision binoculars. In other words, the eyepiece 20, the objective assembly 22, and the first adjustment unit 30 are traditional elements of night vision binoculars, but not the second adjustment unit 32.

The second adjustment unit 32 is able to be controlled by the user.

Preferably, the second unit 32 is able to allow switching from the progressive mode to the traditional mode, and vice versa.

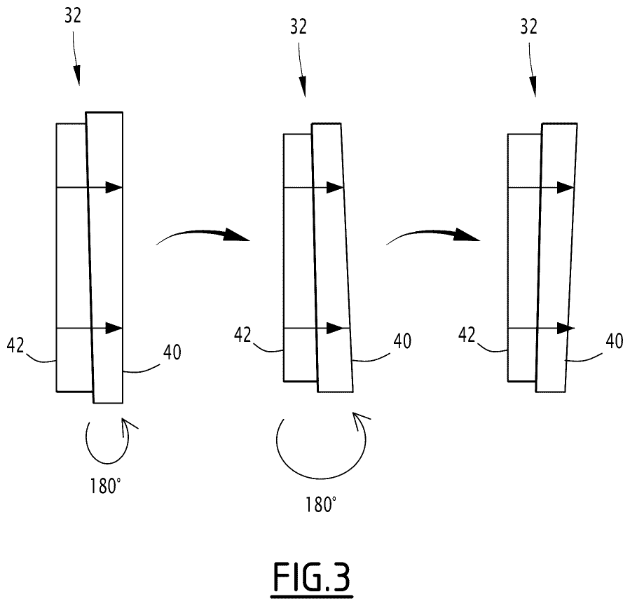

In example embodiments illustrated by FIGS. 2 and 3, the second adjustment unit 32 comprises two complementary-shaped optical components 40, 42 joined together. At least one optical component, called the first component 40, is movable in rotation relative to the other optical component, called the second component 42, so as to modify the angle φ between the normal N to the object plane P_{O} and the optical axis X-X′. The rotation is achieved around an axis substantially parallel to the optical axis X-X′. The modification of this angle φ allows to modify the progressive effect (focus difference between the top of the field of view C_{V} and the bottom of the field of view C_{V} vertically).

In practice, the two optical components 40, 42 are mounted in at least one barrel indexed on the objective assembly 22 (centered on the optical axis X-X′ of the objective assembly 22).

The two plate components 40, 42 are, for example, made of glass or polycarbonate.

Preferably, the two components 40, 42 are also movable in rotation together. This allows to bring the far-field focus to the top of the field of view C_{V} and the near-field focus to the bottom of the field of view C_{V}. This is useful in the case where the rotation of the first component 40 relative to the second component 42 allows different progressive effects to be obtained.

Preferably, the two optical components 40, 42 are positioned in a focus zone of the rays of the objective assembly 22. More precisely, the two optical components 40, 42 are positioned near the image plane of the objective assembly 22 or an intermediate image plane of the objective assembly 22.

Preferably, the two optical components 40, 42 are chosen such that the progressive effect, induced by the rotation of at least one of the components, is linear over the vertical field extent. By linear, it is meant that the variations of the progressive effect are continuous over the vertical field extent of view C_{V}. The two optical components 40, 42 are, for example, two prismatic plates of the same prismatic angle, thus forming a diasporometer. In this case, the two plates are preferably slightly inclined, in other words, the total prismatic angle of the two plates is small, typically less than 5 degrees, preferably less than or equal to 2 degrees.

Alternatively, the two optical components 40, 42 are chosen such that the progressive effect, induced by the rotation of at least one of the components, is non-linear over the vertical field extent. The two optical components 40, 42 are, for example, two lenses, thus forming a doublet. The lenses are, for example, spherical, aspherical, or Freeform.

Preferably, the second adjustment unit 32 presents at least one configuration, called traditional, and one configuration, called maximum progressive.

The traditional configuration corresponds to the traditional mode of the adjustment device 24. The traditional configuration corresponds to a positioning of the first component 40 relative to the second component 42 such that the angle (P between the optical axis X-X′ and the normal N to the object plane P_{O} is zero, thus allowing the focus on a plane perpendicular to the object plane P_{O} (zero progressive effect) to be achieved.

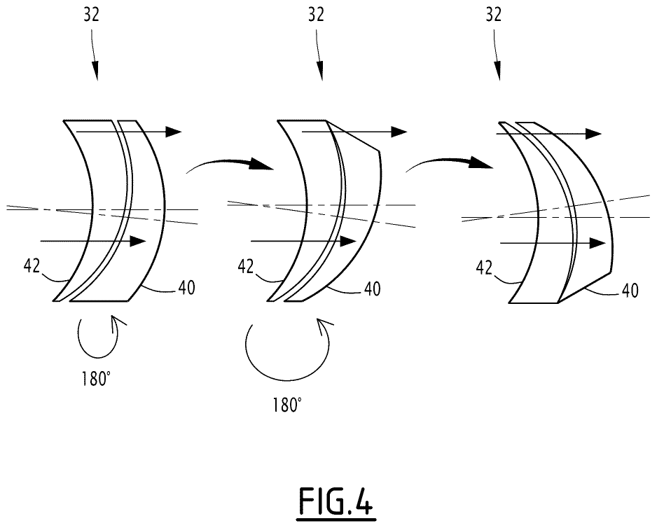

Such a configuration is obtained on the left representations of FIGS. 2 and 3. In particular, the two prismatic plates of FIG. 3 and the two lenses of FIG. 4 are in opposition (head-to-tail) so as not to generate a difference in optical path for two parallel light rays incident on the two optical components 40, 42.

The maximum progressive configuration corresponds to the progressive mode of the adjustment device 24. The maximum progressive configuration corresponds to a rotation of the first component 40 of 180 degrees relative to the traditional configuration so that the progressive effect is maximum.

Such a configuration is obtained on the center and right representations of FIGS. 2 and 3. In particular, on these representations, the two prismatic plates of FIG. 3 and the two lenses of FIG. 4 are facing each other, allowing to generate a maximum optical path difference for two parallel light rays incident on the two optical components 40, 42. In particular, relative to the center representations, the two optical components 40, 42 of the right representations are turned together by 180°.

In particular, in the case of prismatic plates, for two plates of index n, height Y, and for a cumulative prismatic angle θ on the two plates, the maximum optical path difference is obtained in the case where the two plates are facing each other. The maximum difference Δ between the diametrically opposed optical paths is given by the following formula:

Δ=(n−1)*Y*tan(θ)

The focus difference 2d (expressed in diopter) between the top of the field and the bottom of the field (±d relative to the center of the field), expressed in diopter, and called progressive effect, is given by the following formula:

$$2 d = \frac{Δ}{{F}^{2}}$$

Where F is the focal length of the objective assembly 22

The progressive effect, expressed in diopter, is here linear as a function of the vertical field.

Furthermore, as illustrated by FIG. 2, the focus distances being expressed in diopter relative to the position of the objective assembly 22, and expressing in polar coordinates the line “focus plane” (equivalent to the ground in FIG. 2), the angle φ is expressed as a function of the 1/2 field angle α of the objective assembly 22, the progressivity range+/−d, and the focus in the middle of the range D diopter:

$$tan ( φ ) = \frac{D}{d} sin ( α )$$

For example, for plates of index n=1.5, height Y=10 mm, forming a cumulative prismatic angle θ=15°, and an objective assembly 22 of focal length F=20.4 mm with a half-field of view α=25°, we obtain:
Δ=0.26 mm,
2d=0.630 diopters,
φ=23° for a focus in the center of the field at a distance, and
D=0.318 diopters.

In this case, when the user tilts the head 23° toward the ground, they have a sharp vision at more than 300 m on the top of the field of view C_{V} of the binoculars 10, a sharp vision at 3.1 m in the center of the field, and a sharp vision on the bottom of the field of view C_{V} at 1.6 m. This distribution of perceived sharpness in the field is comparable to the sharpness perceived through a progressive lens.

For the same progressive effect, if the user chooses a median focus at 2 m, then the progressive effect is as follows: sharp vision at about 5 m on the top of the field of view C_{V}, at 2 m in the center of the field of view C_{V}, and at 1.2 m at the bottom of the field of view C_{V}.

Note that the transverse offset induces a lack of parallelism x between the entry and exit of the optical path, which is proportional to the distance T and the average index of the medium N separating the last diopter of the diasporometer from the image plane:

$$x = T \cdot tan ( ( n - 1 ) \frac{θ}{N} ) .$$

Nevertheless, this effect is negligible in the case of the present Invention.

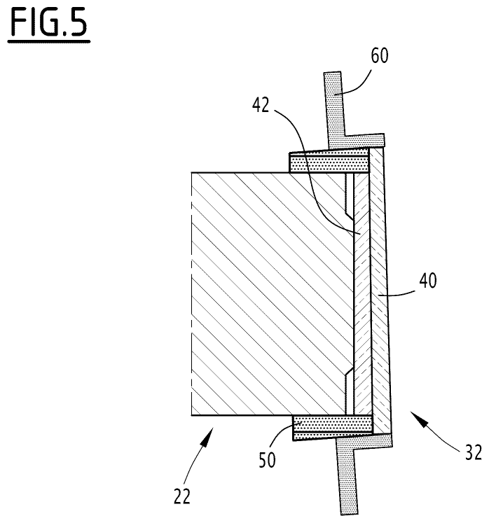

In particular, FIG. 5 illustrates the body of the objective assembly 22 with a retaining ring 50 also holding one of the optical components 40, 42. The other optical component is movable in rotation via a pivot mechanism 60 (barrel in which the first component 40 is mounted, the barrel being movable in rotation via an external command). Thus, in this example, only one of the optical components 40, 42 is movable, and only two configurations are possible: the traditional configuration and the maximum progressive configuration (180° rotation of the movable optical component). The transition from one to the other is, for example, validated by a ratchet or a stop.

Preferably, the second adjustment unit 32 presents at least one configuration, called intermediate progressive, corresponding to:
a first rotation of the first component 40 by an angle strictly between 0° and 180° relative to the traditional configuration so as to obtain an intermediate progressive effect relative to the traditional configuration and the maximum progressive configuration, and
a second joint rotation of the first component 40 and the second component 42 so that the far-field focus is on the upper part (top part) of the field of view and the near-field focus is on the lower part (bottom part) of the field of view.

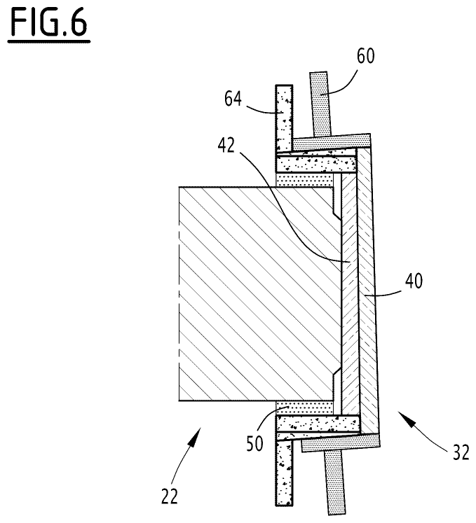

In particular, FIG. 6 illustrates the body of the objective assembly 22 with a retaining ring 50. A first pivot mechanism 62 (barrel in which the first component 40 is mounted, the barrel being pivotable in rotation via an external control) is able to pivot the first component 40. A second pivot mechanism 64 (barrel in which the second component 42 is mounted, the barrel being pivotable in rotation via an external control) is able to pivot both the first and second component 42. Thus, in this example, the first component 40 is movable relative to the second component 42, allowing the angle φ between the optical axis X-X′ and the normal N to the object plane P_{O} to be adapted. The possibility of jointly pivoting the first component 40 and the second component 42 allows to reorient the focus so that the top of the field of view C_{V} corresponds to a far-field focus, and the bottom of the field of view C_{V} corresponds to a near-field focus.

In another alternative embodiment, the second adjustment unit 32 is a prism. In this case, the prism introduces a permanent optical path difference for parallel rays incident on the prism, and therefore a permanent non-zero angle φ between the normal N to the object plane P_{O} and the optical axis X-X′. Thus, in this case, the adjustment device 24 operates only according to the progressive adjustment mode (and not in the traditional adjustment mode). If the prism is not movable in rotation, the progressive effect is also fixed.

An example of focusing the objective assembly 22 of the night vision binoculars 10 is illustrated in the following.

First, the user wishing to focus with a progressive effect (progressive adjustment mode) operates the first adjustment unit 30 and alters the focus distance 1/D to be sharp in at least one zone of the field of view C_{V}, typically in a zone at the center of the field of view C_{V}.

Then, the user manipulates the mechanism (60 in FIGS. 5 and 62 in FIG. 6) allowing to drive in rotation the first component 40 relative to the second component 42, so as to introduce a progressive effect if the previous adjustment mode was a traditional adjustment mode, and to adjust (when possible) the amplitude of the progressive effect.

Possibly, in cases where the second adjustment unit 32 allows an intermediate progressive configuration (FIG. 6 for example) to be obtained, the user operates a mechanism (64 in FIG. 6) allowing to jointly drive in rotation the first component 40 and the second component 42, until the far-field focus is on the top of the field of view C_{V} vertically and the near-field focus is on the bottom of the field of view C_{V} vertically.

In the case of the embodiment of FIG. 5, the user thus manipulates two controls. In the case of the embodiment of FIG. 6, the user manipulates three controls.

A user wishing to focus in traditional mode manipulates the mechanism (60 in FIGS. 5 and 62 in FIG. 6) allowing to drive in rotation the first component 40 relative to the second component 42, until the progressive effect is zero. They then adjust the focus on an object plane P_{O} perpendicular to the optical axis X-X′ via the first adjustment unit 30. Note that switching from a traditional mode to a progressive mode, and vice versa, can only be done when this is possible (in the case of the prism alone, only the progressive adjustment mode is possible).

Thus, the adjustment device 24 of the binoculars 10 allows to focus on the object planes P_{O} not perpendicular to the optical axis X-X′, thus allowing to obtain a focus difference between the top of the field of view C_{V} and the bottom of the field of view C_{V} (progressive effect). This progressive effect allows to facilitate the displacement of a user evolving in an environment where observed objects are both distant and close to the objective assembly 22 of the binoculars 10 (typically between 20 m and 1 m). In particular, once the focus is made, the user visualizes clearly, by a simple movement of the head or eye, a near or distant zone of the observed scene, without having to continuously manipulate a focus control ring. Regarding usability ergonomics, a parallel can be made with the use of progressive lenses in everyday life.

In embodiments where the plates are orientable, the progressive effect is also adaptable by the user, allowing them to choose between a traditional focus mode (no progressive effect) and a progressive mode by giving them the possibility to choose the degree of progressivity.

Such an adjustment device 24 can be integrated into any type of existing night vision binoculars. In particular, it does not reduce the numerical aperture and does not introduce vignetting. The usability capabilities at night level 4 to 5 are fully preserved. Furthermore, it does not require motorization so that the autonomy of the binoculars is not impacted. The solution also preserves the discretion of use.

The skilled person will understand that the previously described embodiments and alternatives can be combined with each other provided they are technically compatible.

1. Night vision binoculars comprising:
an objective assembly having an optical axis axis; and
an adjustment device focusing said objective assembly, the adjustment device presenting a progressive mode, wherein focusing is achieved on object planes not perpendicular to the optical axis so as to allow close-range focusing on one part of a field of view and distant focusing on another part of the field of view.

2. The binoculars according to claim 1, wherein said adjustment device comprises:
a first adjuster for modifying a focusing distance; and
a second adjuster for modifying an adjustable angle between the optical axis and a normal to an object plane.

3. The binoculars according to claim 1, wherein said adjustment device also presents a traditional mode, wherein focusing is achieved on object planes perpendicular to the optical axis.

4. The binoculars according to claim 2, wherein said second adjuster comprises two complementary-shaped optical components joined together, comprising a first component that is movable in rotation relative to a second component, so as to modify the adjustable angle, allowing a progressive effect that modifies a focus difference between a top of the field of view and a bottom of the field of view vertically.

5.-6. (canceled)

7. The binoculars according to claim 4, wherein said two optical components are chosen such that the progressive effect, induced by rotation of at least one of said optical components, is linear over the vertical field extent.

8. The binoculars according to claim 4, wherein said two optical components comprise two prismatic plates.

9. The binoculars according to claim 4, wherein said two optical components are chosen such that the progressive effect, induced by rotation of at least one of said optical components, is non-linear over the vertical field extent.

10. The binoculars according to claim 4, wherein said two optical components comprise two lenses.

11. The binoculars according to claim 3, wherein said second adjuster comprises two complementary-shaped optical components joined together, a first component being movable in rotation relative to a second component, so as to modify the adjustable angle, allowing a progressive effect that modifies a focus difference between a top of the field of view and a bottom of the field of view vertically.

12. The binoculars according to claim 12, wherein said second adjuster presents at least:
a traditional configuration corresponding to the traditional mode, the traditional configuration corresponding to a positioning of said first component relative to said second component such that the adjustable angle is zero, thus allowing focusing on a plane perpendicular to the object plane to be achieved, and
a maximum progressive configuration, corresponding to the progressive mode, the maximum progressive configuration being a rotation of said first component of 180 degrees relative to the traditional configuration so that the progressive effect is maximum.

13. The binoculars according to claim 12, wherein said second adjuster presents an intermediate progressive configuration, corresponding to:
a first rotation of said first component by an angle strictly between 0° and 180° relative to the traditional configuration so as to obtain an intermediate progressive effect relative to the traditional configuration and the maximum progressive configuration, and
a second rotation allowing said first component and said second component to be driven in rotation together, until distant focusing is on the top of the field of view and close-range focusing is on the bottom of the field of view.

14. The binoculars according to claim 4, wherein said two optical components comprise two spherical, aspherical or freeform lenses.
